(19) United States
(12) Patent Application Publication
(10) Pub. No.: US 2006/0241812 A1
(43) Pub. Date: Oct. 26, 2006

(54) Robot system capable of specifying moving area

(75) Inventor: Il-kyun Jung, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/318,499

(22) Filed: Dec. 28, 2005

(30) Foreign Application Priority Data
Apr. 25, 2005 (KR) 10-2005-0034137

(51) Int. Cl. G06F 19/00

(52) U.S. Cl. 700/254

(57) ABSTRACT

A self-moving robot system, which can specify a moving area using information printed on flooring and move within the area while tracking the printed information, is provided. The self-moving robot system includes a remote controller and a self-moving robot body. The remote controller stores flooring coordinate information wirelessly received from the robot body in a memory, displays the information on a display unit, sets a series of coordinate information elements input by a user as moving area coordinate information, and transmits the moving area coordinate information to the robot body. The self-moving robot body reads coordinate information printed on flooring, extracts total coordinate information from the read coordinate information, wirelessly transmits the total coordinate information as flooring coordinate information to the remote controller, reads coordinate information printed on the flooring, and moves while tracking the moving area coordinate information wirelessly received from the remote controller on the flooring.

### BACKGROUND OF THE INVENTION

1. Field of the Invention

The present invention relates to a self-moving robot system, and more particularly to a self-moving robot system which can specify a moving area using information printed on flooring and move within the moving area while tracking the printed information.

2. Description of the Related Art

Robots have been developed for industrial purposes and used as part of factory automation. Robots also have been used, in place of human beings, to collect information in extreme environments that human beings cannot access. Robot technologies have been rapidly developed as applied to the most advanced space development industries. Recently, even human-friendly household robots have been developed. A typical example of the human-friendly household robot is a cleaning robot system.

FIG. 1 is an external view of a general cleaning robot.

As shown in FIG. 1, first sensor units 30 are provided on front and rear portions of a robot body housing 20 of the general cleaning robot. The first sensor units 30 detect obstacles by sending ultrasonic waves and receiving ultrasonic waves reflected from obstacles. About two contact bars 31a are provided on each of the front and rear portions of the robot body housing 20 under the first sensor units 30. Transfer members 31b, which are coupled to the contact bars 31a, extend into the interior of the housing 20. The contact bars 31a are curved along an outer cylindrical surface of the housing 20. The contact bars 31a are also referred to as “contact sensors” since they sense obstacles that they directly contact.

Drive wheels 40 are provided on lower left and right portions of the housing 20 of the general cleaning robot so that the cleaning robot can move freely. Automatic movement of the cleaning robot is achieved by a remote control signal which is transmitted from a remote controller 50, received by a remote control receiver 60 on the housing 20, and transferred to a controller that controls the operation of motors for driving the wheels 40.

A method employing a magnetic tape and a method employing a separate infrared beam transmitter are used to limit automatic movement of the general cleaning robot configured as described above.

The former method limits movement of the robot body by attaching a magnetic tape to flooring and attaching a hall sensor to the cleaning robot body. The latter method limits movement of the robot body in such a manner that an infrared beam transmitter is used to transmit an infrared beam and the robot body is prevented from moving in the opposite direction to the direction of the infrared beam.

However, the former method must use the magnetic tape. This increases the cost of the cleaning robot system. There are also many restrictions in installing the magnetic tape since the magnetic tape affects electrical household appliances, electronic cards, etc.

The latter method is economically inefficient since it requires an additional purchase of an infrared beam transmitter, and batteries of the infrared beam transmitter must also be periodically replaced.

### SUMMARY OF THE INVENTION

Therefore, the present invention has been made in view of the above problems, and it is an object of the present invention to provide a self-moving robot system which allows a user to easily set a moving area using a remote controller without requiring separate equipment such as an infrared beam transmitter and without causing inconvenience to the user so that a robot body can move within the set moving area.

It is another object of the present invention to provide a self-moving robot system wherein information of coordinates printed on flooring is acquired and transmitted to a device, which can be used as a remote controller, and a robot body moves within a defined moving area transmitted from the device.

It is yet another object of the present invention to provide a self-moving robot system wherein a cleaning area is specified using a portable device having a local area communication function and a robot body cleans the cleaning area while moving within the cleaning area.

In accordance with one aspect of the present invention, the above and other objects can be accomplished by the provision of a self-moving robot system comprising a printed information reader for reading coordinate information printed on flooring; a moving area coordinate information extraction unit for extracting moving area coordinate information from a wirelessly received remote control signal; a moving start point setting unit for locating an adjacent coordinate information element from among a plurality of coordinate information elements included in the extracted moving area coordinate information and setting the located coordinate information element as a moving start point; and a coordinate information tracking unit for controlling the operation of a motor so that a robot body moves to the moving start point and moves within the moving area while tracking the coordinate information present in the moving area.

Since the robot body locates and moves to a coordinate information element near its current position from among a plurality of coordinate information elements included in moving area coordinate information transmitted from the remote controller, and moves within the moving area while tracking the coordinate information elements present in the moving area, it is possible to conveniently limit movement of the robot body without requiring separate equipment and without causing inconvenience to the user.

In accordance with another aspect of the present invention, the self-moving robot system further comprises a flooring coordinate information extraction unit for extracting information (hereinafter referred to as total coordinate information (n×m)) of coordinates printed vertically and horizontally on the flooring from the coordinate information read through the printed information reader; and a flooring coordinate information transmitter for transmitting the extracted total coordinate information to the remote controller through a wireless communication unit.

Since total coordinate information including the total number of coordinate information elements printed vertically and horizontally on flooring can be transmitted to the remote controller, the remote controller can store the total coordinate information in a memory and use it when setting a moving area, so that it is possible to appropriately adapt to situations such as replacement of the flooring.

In addition, since the total coordinate information can be wirelessly transmitted to a portable device capable of communicating with the robot body, the portable device can be used as a remote controller capable of setting a moving area, so that it is possible to normally control movement of the robot body, in spite of loss or failure of the remote controller.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an external view of a general cleaning robot system;

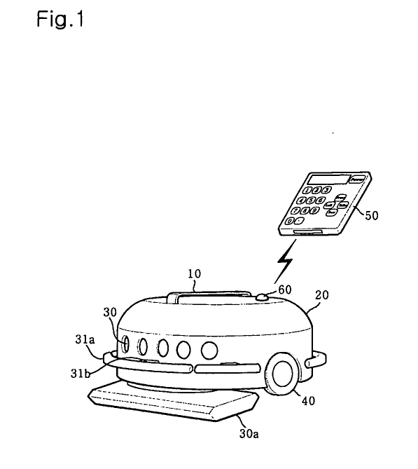

FIG. 2 is a block diagram of a self-moving robot system according to an embodiment of the present invention;

FIG. 3 illustrates the positions of barcodes displayed on a display unit of a remote controller 100 shown in FIG. 2;

FIG. 4 illustrates the positions of barcodes actually printed on flooring according to an embodiment of the present invention; and

FIG. 5 illustrates how the self-moving robot system according to the embodiment of the present invention reads barcodes printed on the flooring.

### DESCRIPTION OF THE PREFERRED EMBODIMENTS

Now, preferred embodiments of the present invention will be described in detail with reference to the accompanying drawings. In the following description of the present invention, a detailed description of known functions and configurations incorporated herein will be omitted when it may obscure the subject matter of the present invention.

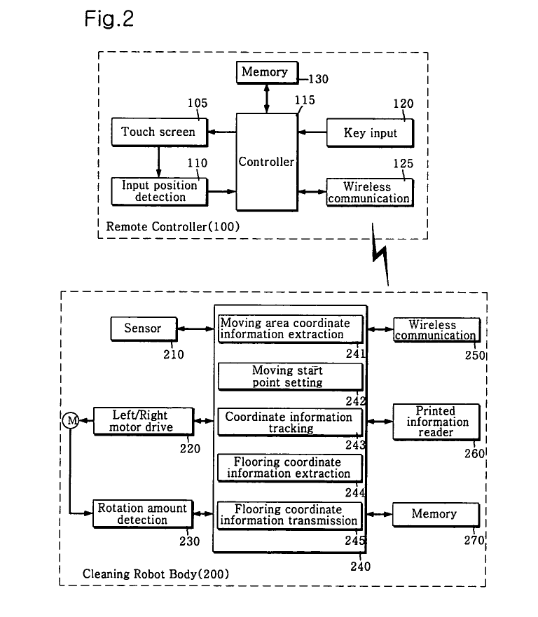

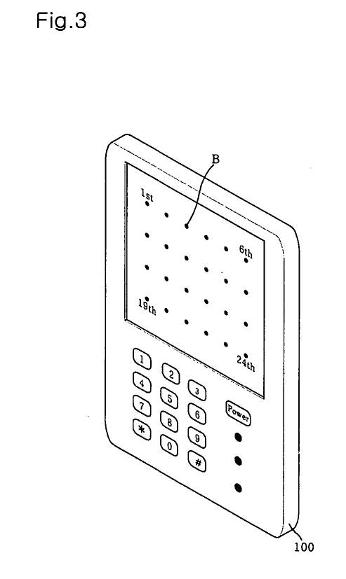

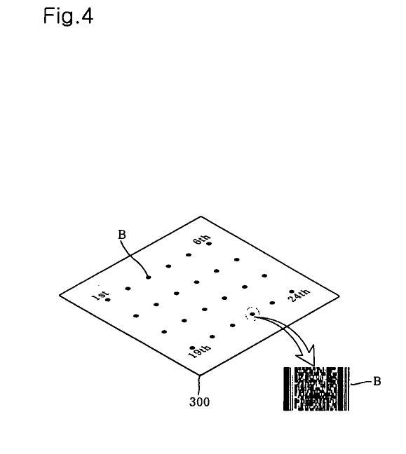

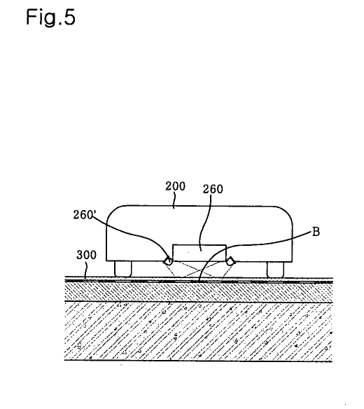

FIG. 2 is a block diagram of a self-moving robot system (more particularly, a cleaning robot system) according to an embodiment of the present invention. FIG. 3 shows the positions of barcodes displayed on a display unit of a remote controller 100 shown in FIG. 2, and FIG. 4 shows the positions of barcodes actually printed on flooring according to an embodiment of the present invention. FIG. 5 shows how the self-moving robot system according to the embodiment of the present invention reads barcodes printed on the flooring.

As shown in FIG. 2, the cleaning robot system according to the embodiment of the present invention largely includes a cleaning robot body 200 and a remote controller 100 which remotely controls the cleaning robot body 200.

The remote controller 100 may be an accessory of the cleaning robot body 200 or may be a portable/mobile communication terminal such as a mobile phone or a PDA having a local area communication module such as a Bluetooth module. In some cases, the remote controller 100 may be a home network device such as a digital TV or a central interphone which has a wireless LAN module or a Zigbee module and thus can communicate with the robot body 200.

As shown in FIG. 2, the remote controller 100 basically includes a wireless communication module 125, a memory 130, a display unit, a data input unit, and a controller 115. The wireless communication module 125 communicates with the robot body 200. The memory 130 stores information of coordinates printed on flooring. The display unit displays the coordinate information. The data input unit allows a user to set a moving area. The controller 115 controls these components to store and display the coordinate information and to transmit coordinate information of a moving area selected by the user.

For example, the wireless communication module 125 may be embodied as an infrared transmitter, a wireless local area communication module such as a Bluetooth module, a wireless LAN module, or a Zigbee module, or the like, depending on the system. The coordinate information stored in the memory 130 is specifically information about coordinate information elements printed vertically and horizontally (i.e., in matrix form) on the flooring. More specifically, the coordinate information is total flooring coordinate information (n×m), which is a value input or changed by a manager and stored in the memory 130 or a value transmitted from the robot body 200 and stored in the memory 130. In FIG. 2, the display unit for displaying the coordinate information is exemplified by a touch screen 105, and the data input unit for setting the moving area is exemplified by a key input unit 120 including a number of buttons together with the touch screen 105. An input position detection unit 110, which is not described above, detects a moving area specification position input on the touch screen 105. Under the control of the controller 115, the moving area specification position information detected through the input position detection unit 110 is transmitted as moving area coordinate information. Under the control of the controller 115, total flooring coordinate information (n×m) transmitted from the robot body 200 is stored and managed in the memory 130.

A description will now be given of the cleaning robot body 200, the movement of which is controlled by the remote controller 100 constructed as described above.

As with the general robot body, the self-moving robot body 200 according to the embodiment of the present invention includes a sensor unit 210 having a plurality of sensors for sensing obstacles and cliffs. For movement of the robot body 200, the self-moving robot body 200 further includes a left/right wheel motor drive unit 220 and rotation amount detectors (for example, rotation counters) 230. The left/right wheel motor drive unit 220 drives left and right wheel motors M according to drive control signals received from a body controller 240 described below. The rotation amount detectors 230 are coupled respectively to left and right wheels to detect the rotation amounts of the left and right wheels and then to feed data of the number of rotations corresponding to the rotation amounts back to the body controller 240.

The cleaning robot body 200 according to the embodiment of the present invention further includes a wireless communication unit 240 for wireless communication with the remote controller 100. As described above for the remote controller 100, this wireless communication module 250 may be embodied as an infrared transmitter, a wireless local area communication module such as a Bluetooth module, a wireless LAN module, or a Zigbee module, or the like. Of course, the wireless communication module 250 may also include a variety of communication modules complying with different communication protocols in order to communicate with a variety of devices.

The cleaning robot body 200 further includes a printed information reader 260. The printed information reader 260 is mounted on a lower portion of the body 200 as shown in FIG. 5 to read coordinate information elements printed with colorless or secret ink which produces a color when receiving light emitted from a light emitting element 260′. Each of the coordinate information elements is represented by a 2-dimensional barcode B as shown in FIG. 4. Of course, the coordinate information may be printed in other formats such as general barcodes.

The controller 240 controls the operation of the robot body 200 based on control program data stored in the memory 270. For example, the controller 240 controls the operation of the robot body 200 based on a plurality of program modules or units 241-245 as shown in FIG. 2.

Specifically, a moving area coordinate information extraction unit 241 extracts moving area coordinate information from a remote control signal received through the wireless communication module 250.

A moving start point setting unit 242 locates an adjacent coordinate information element from among a plurality of coordinate information elements included in the moving area coordinate information extracted by the moving area coordinate information extraction unit 241 and sets the located adjacent coordinate information as a moving start point.

A coordinate information tracking unit 243 controls the operation of left and right wheel motors M so that the body 200 moves to the moving start point set by the moving start point setting unit and the body 200 moves within the moving area while tracking all coordinate information elements present in the moving area.

The system of the cleaning robot body 200 may also be implemented by including a flooring coordinate information extraction unit 244 and a flooring coordinate information transmission unit 245, in addition to the moving area coordinate information extraction unit 241, the moving start point setting unit 242, and the coordinate information extraction unit 243. The flooring coordinate information extraction unit 244 extracts total coordinate information (n×m) of the coordinate information elements, which have been printed vertically and horizontally on the flooring, from the flooring coordinate information read by the printed information reader 260. The flooring coordinate information transmission unit 245 transmits the extracted total flooring coordinate information to the remote controller 100 through the wireless communication module 250.

A robot body, which simply receives coordinate information of a moving area and moves within the moving area while tracking coordinate information present in the moving area, can be assumed to be a self-moving robot system according to a first embodiment of the present invention.

A robot system, which includes a remote controller 100 having a memory where total coordinate information (n×m) printed on the flooring has been stored and a robot body which is controlled by the remote controller, can be assumed to be a self-moving robot system according to a second embodiment of the present invention.

A robot system, wherein a robot body obtains total coordinate information (n×m) printed on the flooring and transmits it to a remote controller 100, can be assumed to be a self-moving robot system according to a third embodiment of the present invention.

Now, operations of a self-moving robot system according to the embodiments of the present invention will be described in detail with reference to the accompanying drawings.

First, a description will be given of how the cleaning robot body 200 obtains and transmits total coordinate information (n×m) of the coordinate information elements, which have been printed vertically and horizontally on the flooring, to the remote controller 100.

A user places the cleaning robot body 200 on flooring 300 as shown in FIG. 4 and uses the remote controller 100 to move the robot body 200. It is assumed that 6×4 2-dimensional barcodes B have been printed vertically and horizontally (i.e., in a 6×4 matrix) on the flooring 300. It is also assumed that the 2-dimensional barcodes contain both their own position coordinate information, such as first coordinates (1,1), second coordinates (1,2), . . . , and 24th coordinates (4,6), and total coordinate information (n×m) of the barcodes printed on the flooring. That is, each coordinate information element (i.e., each barcode) includes its position coordinate information and the total coordinate information.

When the robot body 200 moves on the flooring 300 under the above assumptions, the robot body 200 can read a coordinate information element (i.e., a 2-dimensional barcode) printed on the flooring 300 through the light emitting element 260′ and the printed information reader 260 mounted on the bottom of the robot body 200 as shown in FIG. 5. Specifically, when the light emitting element 260′ emits light of a specific wavelength range as power is applied to the light emitting element 260′, the 2-dimensional barcode, which has been chemically treated so as to produce a color in response to the specific wavelength range, is detected by the printed information reader 260. The detected barcode information is transferred to the flooring coordinate information extraction unit 244. The flooring coordinate information extraction unit 244 then extracts total coordinate information of the coordinate information elements printed on the flooring from the detected barcode (coordinate) information and transfers the extracted total coordinate information to the flooring coordinate information transmitter 245. The flooring coordinate information transmitter 245 then wirelessly transmits the extracted total coordinate information as flooring coordinate information.

The flooring coordinate information wirelessly transmitted from the cleaning robot body 200 is received by the wireless communication module 125 in the remote controller 100 and is then stored in the memory 130 under the control of the controller 115.

A description will now be given of how a moving area is specified using the remote controller 100 that has received flooring coordinate information from the cleaning robot body 200 or using the remote controller 100 having a memory 130 in which flooring coordinate information has been stored by a manufacturer, a manager, or the like, and how the cleaning robot body 200 moves within the specified moving area.

When a user desires to specify a moving area, the user instructs the remote controller 100 to display flooring coordinate information. The controller 115 in the remote controller 100 then reads and displays flooring coordinate information stored in the memory 130 on the touch screen 105 which functions as a display unit. An example of the coordinate information displayed on the touch screen 105 is illustrated in FIG. 3. If n×m flooring coordinate information elements are displayed on the touch screen 105 as illustrated in FIG. 2, the user can input positions to specify a desired moving area on the touch screen 105. The positions for specifying the moving area can also be input using direction or number keys. In the embodiment of the present invention, it is assumed that the moving area is specified by 1st, 6th, 19th, and 24th coordinate information elements.

Once the user inputs the positions to specify the moving area as described above, the input position detection unit 110 detects and transfers the moving area specification position information to the controller 115. The controller 115 then sets the moving area specification position information as moving area coordinate information and transmits it to the cleaning robot body 200 through the wireless communication module 125.

The moving area coordinate information wirelessly transmitted from the remote controller 100 is transferred, as part of a remote control signal, to the coordinate information extraction unit 241 through the wireless communication module 250 of the robot body 200. The moving area coordinate information extraction unit 241 extracts the moving area coordinate information from the wirelessly received remote control signal, and transfers it to the moving start point setting unit 242. The moving start point setting unit 242 locates a coordinate information element near the current position from among a plurality of coordinate information elements included in the extracted moving area coordinate information, and sets the located coordinate information element as a moving start point. For example, when the coordinate information element currently read by the printed information reader 269 is (2,2) and the received moving area coordinate information elements are (1,1), (1,6), (4,1), and (4,6), the moving start point setting unit 242 sets the coordinates (1,1) as the coordinates of the moving start point.

When the moving start point has been set, the coordinate information tracking unit 243 controls the operation of the motors so that the body 200 moves to the moving start point. When the robot body 200 has moved to the moving start point, the coordinate information tracking unit 243 controls the operation of the motor so that the body 200 moves within the moving area set by the user while tracking all coordinate information elements present in the set moving area.

Accordingly, the cleaning robot body 200 can normally clean the area specified by the user.

The embodiments of the present invention have been described assuming that the remote controller 100 and the cleaning robot body 200 constitute a single self-moving robot system. However, a mobile communication terminal or a home network device capable of performing wireless local area communication, which is not an accessory of the cleaning robot body 200, may also be set as the remote controller 100 and be combined with the cleaning robot body 200 to constitute a single self-moving robot system. This is possible since electrical household appliances or communication devices having a wireless local area communication module or mobile communication terminals such as mobile phones or PDAs, which comply with different communication protocols, can control the movement of the cleaning robot body 200 according to the operating principle described above.

As is apparent from the above description, a robot system according to the present invention has a variety of advantages. For example, a robot body locates and moves to a coordinate information element near its current position from among a plurality of coordinate information elements included in the moving area coordinate information transmitted from a remote controller, and moves within the moving area while tracking the coordinate information elements present in the moving area, so that it is possible to conveniently limit movement of the robot body without requiring separate equipment and without causing inconvenience to the user.

Further, since total coordinate information including the total number of coordinate information elements printed vertically and horizontally on flooring can be transmitted to the remote controller, the remote controller can store the total coordinate information in a memory and use it when setting a moving area, so that it is possible to appropriately adapt to situations such as replacement of the flooring.

In addition, since the total coordinate information can be wirelessly transmitted to a portable device capable of communicating with the robot body, the portable device can be used as a remote controller capable of setting a moving area, so that it is possible to normally control movement of the robot body, in spite of loss or failure of the remote controller.

Although the preferred embodiments of the present invention have been disclosed for illustrative purposes, those skilled in the art will appreciate that various modifications of the above embodiments and other equivalent embodiments are possible, without departing from the scope and spirit of the invention as disclosed in the accompanying claims.

What is claimed is:

1. A self-moving robot system comprising:
a remote controller for performing wireless communication with a self-moving robot body; and
the self-moving robot body for extracting moving area coordinate information from a remote control signal wirelessly received from the remote controller, reading coordinate information printed on flooring, and moving while tracking the extracted moving area coordinate information on the flooring.

2. The self-moving robot system according to claim 1, wherein the self-moving robot body includes:
a printed information reader for reading the coordinate information printed on the flooring;
a moving area coordinate information extraction unit for extracting the moving area coordinate information from the remote control signal wirelessly received from the remote controller;
a moving start point setting unit for setting, as a moving start point, a coordinate information element nearest to the self-moving robot body from among a plurality of coordinate information elements included in the extracted moving area coordinate information; and
a coordinate information tracking unit for controlling the operation of a motor so that the self-moving robot body moves to the moving start point and then moves while tracking the moving area coordinate information on the flooring.

3. The self-moving robot system according to claim 2, wherein the coordinate information printed on the flooring includes a plurality of coordinate information elements and each of the coordinate information elements includes both total coordinate information of the coordinate information elements printed on the flooring and position coordinate information of the coordinate information element.

4. The self-moving robot system according to claim 2, wherein the self-moving robot body further includes:
a flooring coordinate information extraction unit for extracting total coordinate information of a plurality of coordinate information elements printed on the flooring from the coordinate information read by the printed information reader; and
a flooring coordinate information transmission unit for transmitting the extracted total coordinate information as flooring coordinate information to the remote controller through a wireless communication module.

5. The self-moving robot system according to claim 2, wherein the remote controller includes:
a wireless communication module for performing wireless communication with the self-moving robot body;
a memory for storing the coordinate information printed on the flooring;
a display unit for displaying the coordinate information;
a data input unit for receiving information for setting a moving area, input by a user; and
a control unit for controlling overall operations of the remote controller to store and display the coordinate information and to wirelessly transmit the coordinate information to the self-moving robot body.

6. The self-moving robot system according to claim 5, wherein the data input unit includes one or both of a touch screen and a key input unit.

7. The self-moving robot system according to claim 6, wherein the remote controller further includes:
an input position detection unit for detecting a position input on the touch screen as a position to specify a moving area and outputting the moving area specification position information to the control unit.

8. A self-moving robot system comprising:
a remote controller for extracting and displaying a plurality of previously stored coordinate information elements printed on flooring, setting a series of coordinate information elements input by a user as moving area coordinate information, and transmitting the moving area coordinate information to a self-moving robot body; and
the self-moving robot body for reading coordinate information printed on the flooring and moving while tracking the moving area coordinate information wirelessly received from the remote controller on the flooring.

9. The self-moving robot system according to claim 8, wherein the self-moving robot body includes:
a printed information reader for reading the coordinate information printed on the flooring;
a moving start point setting unit for setting, as a moving start point, a coordinate information element nearest to the self-moving robot body from among a plurality of coordinate information elements included in the moving area coordinate information wirelessly received from the remote controller; and
a coordinate information tracking unit for controlling the operation of a motor so that the self-moving robot body moves to the moving start point and then moves while tracking the moving area coordinate information on the flooring.

10. The self-moving robot system according to claim 9, wherein the coordinate information printed on the flooring includes a plurality of coordinate information elements and each of the coordinate information elements includes both total coordinate information of the coordinate information elements printed on the flooring and position coordinate information of the coordinate information element.

11. The self-moving robot system according to claim 9, wherein the self-moving robot body further includes:
a flooring coordinate information extraction unit for extracting total coordinate information of a plurality of coordinate information elements printed on the flooring from the coordinate information read by the printed information reader; and
a flooring coordinate information transmission unit for transmitting the extracted total coordinate information as flooring coordinate information to the remote controller through a wireless communication module.

12. The self-moving robot system according to claim 9, wherein the remote controller includes:
a wireless communication module for performing wireless communication with the self-moving robot body;
a memory for storing the coordinate information printed on the flooring;
a display unit for displaying the coordinate information;
a data input unit for receiving information for setting a moving area, input by a user; and
a control unit for controlling overall operations of the remote controller to store and display the coordinate information and to wirelessly transmit the coordinate information to the self-moving robot body.

13. The self-moving robot system according to claim 12, wherein the data input unit includes one or both of a touch screen and a key input unit.

14. The self-moving robot system according to claim 13, wherein the remote controller further includes:
an input position detection unit for detecting a position input on the touch screen as a position to specify a moving area and outputting the moving area specification position information to the control unit.

15. A self-moving robot system comprising:
a remote controller for storing flooring coordinate information wirelessly received from a self-moving robot body in a memory, displaying the flooring coordinate information on a display unit, setting a series of coordinate information elements input by a user as moving area coordinate information, and transmitting the moving area coordinate information to the self-moving robot body; and
the self-moving robot body for reading coordinate information printed on flooring, extracting total coordinate information from the read coordinate information, wirelessly transmitting the extracted total coordinate information as flooring coordinate information to the remote controller, reading coordinate information printed on the flooring, and moving while tracking the moving area coordinate information wirelessly received from the remote controller on the flooring.

16. The self-moving robot system according to claim 15, wherein the self-moving robot body includes:
a printed information reader for reading the coordinate information printed on the flooring;
a flooring coordinate information extraction unit for extracting total coordinate information of a plurality of coordinate information elements printed on the flooring from the coordinate information read by the printed information reader;
a flooring coordinate information transmission unit for transmitting the extracted total coordinate information as flooring coordinate information to the remote controller through a wireless communication module; and
a moving start point setting unit for setting, as a moving start point, a coordinate information element nearest to the self-moving robot body from among a plurality of coordinate information elements included in the moving area coordinate information wirelessly received from the remote controller; and
a coordinate information tracking unit for controlling the operation of a motor so that the self-moving robot body moves to the moving start point and then moves while tracking the moving area coordinate information on the flooring.

17. The self-moving robot system according to claim 16, wherein the coordinate information printed on the flooring includes a plurality of coordinate information elements and each of the coordinate information elements includes both total coordinate information of the coordinate information elements printed on the flooring and position coordinate information of the coordinate information element.

18. The self-moving robot system according to claim 16, wherein the remote controller includes:
a wireless communication module for performing wireless communication with the self-moving robot body;
a memory for storing the flooring coordinate information wirelessly received from the self-moving robot body;
a display unit for displaying the flooring coordinate information;
a data input unit for receiving information for setting a moving area, input by a user; and
a control unit for controlling overall operations of the remote controller to store and display the coordinate information and to wirelessly transmit and receive the coordinate information to and from the self-moving robot body.

19. The self-moving robot system according to claim 18, wherein the data input unit includes one or both of a touch screen and a key input unit.

20. The self-moving robot system according to claim 19, wherein the remote controller further includes:
an input position detection unit for detecting a position input on the touch screen as a position to specify a moving area and outputting the moving area specification position information to the control unit.
